(19) United States
(12) Patent Application Publication
(10) Pub. No.: US 2011/0259373 A1
(43) Pub. Date: Oct. 27, 2011

(54) METHOD AND AGENT FOR SURFACE PROCESSING OF PRINTED CIRCUIT BOARD SUBSTRATE

(75) Inventors: Teruyuki Hotta, Osaka (JP); Takahiro Ishizaki, Osaka (JP)

(73) Assignee: C. UYEMURA CO., LTD, Osaka (JP)

(21) Appl. No.: 13/090,003

(22) Filed: Apr. 19, 2011

(30) Foreign Application Priority Data
Apr. 21, 2010 (JP) P2010-097702

(51) Int. Cl. B08B 3/00

(52) U.S. Cl. 134/27; 134/95.1

(57) ABSTRACT

A surface processing method and a surface processing agent for effectively removing smear produced in a via or the like are disclosed. The smear is to be removed without etching an inner metalized layer without using expensive permanganates that might impose a greater load on an environment and operators. By removing the smear, the tightness in adhesion between an inner metalized circuit layer and plating metal as well as reliability in electrical connection may be improved. To this end, a surface processing method for a resin-containing substrate of a printed circuit board is provided in which the smear left in an opening, such as a blind via, a through-hole or a trench, formed in the substrate, may be removed without etching a metalized inner layer. The surface processing method immerses the interconnect substrate in a weakly acidic to weakly alkaline first processing solution at least containing hydrogen peroxide and subsequently in a second processing solution at least containing an alkali compound and an organic solvent.

### BACKGROUND OF THE INVENTION

1. Field of the Invention

This invention relates to a method and an agent for surface processing of a resin-containing substrate of a printed circuit board. More particularly, it relates to a method and an agent for surface processing of the resin-containing substrate of the printed circuit board for removing smear left over say in blind vias, through-holes or trenches, formed in the resin-containing printed circuit board substrate.

2. Description of Related Art

In a multi-layer printed circuit board of a thin thickness and a high density, used for electrical equipment, blind vias or through-holes for interconnecting a plurality of conductors or trenches for composing a circuit are used. These blind vias, through-holes or trenches are referred to below as vias or the like.

These vias or the like are formed by drilling or laser processing. In the course of the drilling or laser processing, resin dross, referred to below as smear, tends to be formed on the inner wall of the vias or on the substrate surface. This smear may render the processing of subsequent copper plating difficult or otherwise may give rise to such problems as deteriorated adhesion between the circuit formed and the resin substrate or between a copper layer formed on the inner wall of the via and plating copper and deteriorated interconnect reliability.

To remove the smear produced, a wet smear-removing (de-smearing) processing has so far been used. The wet smear-removing processing may include process steps of ultrasonic rinsing, swelling, water-washing, de-smearing by permanganates or chromates, second water-washing, neutralization, further water-washing and drying.

In Patent Documents 1 to 5, for example, there is disclosed a method for de-smearing according to which a multilayer laminated plate from the laser working process is first put to swelling processing and the so processed laminated plate is processed with a solution of potassium permanganate. This potassium permanganate is then reduced and removed by way of processing for neutralization, thereby removing the smear.

However, the permanganates, used in the routine de-smearing processing, are medicals that fall under specified chemical substances as provided for in Occupational Health and Safety Law. Thus, in handling them, sufficient attention needs to be paid for the sake of safety. Moreover, those who handle the permanganates are obliged to receive health check periodically. The use of the permanganates, as potent oxidizer, gives rise to the problems in management, such as environmental pollution, disposal or preservation. In addition, there is posed a problem that those portions of the substrate of the printed circuit board that are not in need of de-smearing processing are damaged as a result of the de-smearing processing with permanganates.

After the de-smearing processing, which uses the above mentioned permanganates, soft etching is applied to remove the smear left on the surface of the metalized circuit. However, such soft etching may result in excess etching that removes even the inner metalized layer to give rise to non-optimum plating or to failures in electrical conductivity to detract from interconnect reliability.

### RELATED TECHNICAL DOCUMENTS

### Patent Documents

[Patent Document 1] Japanese Laid-Open Patent Publication H5-167249
[Patent Document 2] Japanese Laid-Open Patent Publication H6-314869
[Patent Document 3] Japanese Laid-Open Patent Publication 2002-124753
[Patent Document 4] Japanese Laid-Open Patent Publication 2007-129147
[Patent Document 5] Japanese Laid-Open Patent Publication 2007-158238

### SUMMARY OF THE INVENTION

### Problems to be Solved by the Invention

In view of these problems of the related art, it is desirable to provide a surface processing method and a surface processing agent for effectively removing the smear produced say in vias or the like to improve tightness in adhesion between an inner layer metalized circuit and plating metal while improving the interconnect reliability. It is envisaged by the present invention to effect such smear removal without etching metalized inner layers without using permanganates or chromates which are expensive and which moreover impose significant loads on the environment and on operators.

### Means to Solve the Problem

To solve the above problem, the present inventors have conducted eager searches, and found out that, by processing a substrate of a printed circuit board with a processing solution containing hydrogen peroxide and another processing solution containing an alkaline compound and an organic compound, it is possible to effectively remove the smear to improve tightness in adhesion between the inner metalized circuit layer and plating metal to render it possible to fabricate an interconnect substrate of high interconnect reliability.

In one aspect, the present invention provides a method for surface processing a resin-containing interconnect substrate of a printed circuit board for removing smear left in an opening formed in the interconnect substrate without etching an inner metal layer. The opening may include a blind via, a through-hole or a trench. The method comprises a first processing step of immersing the substrate of the printed circuit board in a weakly acidic to weakly alkaline first processing solution at least containing hydrogen peroxide, and a second processing step of immersing the substrate of the printed circuit board, processed by the first processing step, in a second processing solution at least containing an alkaline compound and an organic solvent.

In a second aspect, the present invention provides a surface processing agent for processing a resin-containing interconnect substrate of a printed circuit board for removing smear left in an opening formed in the interconnect substrate without etching an inner metal layer. The opening may include a blind via, through-hole or a trench. The surface processing agent comprises a weakly acidic to weakly alkaline first processing solution at least containing hydrogen peroxide and a second processing solution at least containing an alkaline compound and an organic solvent. The substrate of the printed circuit board is processed with the first processing solution and then processed with the second processing solution.

Preferably, the first processing solution has a pH of not less than 4 and not more than 8.

Preferably, the organic solvent, contained in the first processing solution, is at least one selected from the group consisting of glycols, glycol ethers, alcohols, cyclic ethers, cyclic ketones, lactams and amides.

Preferably, the first processing solution further contains a stabilizer for hydrogen peroxide. The stabilizer for hydrogen peroxide is preferably at least one selected from the group consisting of amines, glycols and glycol ethers.

Preferably, ultrasonic processing is effected in at least one of the first and second processing steps.

In case the printed circuit board includes a copper interconnect, the first processing solution preferably further contains a chelating agent for copper. The chelating agent for copper preferably contains at least one selected from the group consisting of amines, polyamines, alkanolamines, carboxylic acids, amino acids, amino polycarboxylic acids, phosphonic acids, sulfonic acids and salts thereof.

### Effect of the Invention

According to the present invention, the smear formed in vias or the like may effectively be removed without using permanganates or chromates without etching an inner metalized layer. The permanganates or chromates might impose significant loads on the environment or on operators, while being expensive. According to the present invention, it is moreover possible to improve the tightness in adhesion between the inner metalized circuit layer and plating metal to enable a substrate of a printed circuit board of optimum interconnect reliability to be produced efficiently.

### BEST MODE FOR CARRYING OUT THE INVENTION

The method for surface processing of a printed circuit board as well as the agent for surface processing according to preferred embodiments of the present invention will now be described in the following sequence in detail.

### <1. Summary>

<2. Method for surface processing of the present embodiment>
<2-1 On the interconnect substrate>
<2.2. On the formation of vias or the like>
<2-3. On the first processing step>
<2-3-1. First processing solution>
<2-3-2. First processing step>
<2-4. On the second processing step>
<2-4-1. Second processing solution>
<2-4-2. Second processing step>
<3. Plating processing>

### <4. Summary>

### <5. Examples>

### 1. Summary

The method for surface processing a substrate of a printed circuit board of the present embodiment is a surface processing method for a resin-containing substrate, in which an opening, including a blind via hole, a through-hole or a trench, has been formed by drill or laser working. The blind via hole, through-hole or the trench is sometimes referred to below as ‘via or the like’, while the resin-containing interconnect substrate of the printed circuit board, is sometimes referred to below simply as ‘interconnect substrate’.

Viz., the method for surface processing according to the present embodiment is characterized by having a first processing step of immersing an interconnect substrate in the weakly acidic to weakly alkaline first processing solution which at least contains hydrogen peroxide, and a second processing step of immersing the interconnect substrate from the first processing step in the second processing solution which at least contains an alkaline compound and an organic solvent.

Thus, in the surface processing method of the present embodiment, in which the interconnect substrate is processed with the first and second processing solutions, as later explained in detail, it is possible to effectively remove the smear produced in the via or the like. In removing the smear, in the related art, the de-smearing processing which uses expensive permanganates or chromates, liable to impose severe loads on the environment or operators, is not made, while the inner metalized layer is not etched. With the present method for surface processing, it is possible to prepare an interconnect substrate with improved tightness in adhesion between the inner metalized circuit layer and plating metal as well as with improved interconnect reliability. The surface processing method according to the present embodiment will now be explained in further detail.

### 2. Method for Surface Processing of the Present Embodiment

### <2-10 On the Interconnect Substrate>

The method for surface processing according to the present embodiment is a smear removing (de-smearing) method of effectively removing the smear produced in working/forming a via in a resin-containing interconnect substrate. There is no particular limitation to the insulation resin material for the substrate which may be used in the present method for surface processing, such that any known insulation resin material may be used in the present invention.

Specifically, the insulation resin material that may be used may be multifarious and exemplified an epoxy resin (EP resin), films of thermosetting resins, including a polyimide resin (PI resin), a bismaleido-triazine resin (BT resin) and polyphenylene ether resin (PPE resin), and films of thermoplastic resins, including a liquid crystal polymer (LCP), a polyether ether ketone resin (PEEK resin), a polyether imide resin (PEI resin) and a polyether sulfone resin (PES resin). The insulation resin material may also be a plate or a resilient film of a resin-resin composite material, obtained on impregnating a fluorine-based resin substrate of a three-dimensional network structure, such as continuously porous PTFE, with a thermosetting resin, such as EP resin. The most preferred resin is such a one that exhibits sufficient resistance against a variety of negative process conditions encountered in the course of a subsequent electroless plating step. For example, it is desirable for the resin to form no harmful eluents that may be ejected into the plating bath as well as to be not susceptible to interfacial delamination. It is also desirable for the resin to exhibit resistance against the stress encountered during the process steps, such as sufficient tightness in adhesion with respect to a circuit surface or to overlying and underlying layers. It is further desirable for the resin not to be susceptible to delamination or cracking in the course of tests such as cooling/heating cyclic tests.

The substrate of the insulation resin material may be of a multi-layered structure made up of a plurality of substrates each including an electrically conductive layer. The substrate may also be a double-sided substrate. Fillers or glass fibers may be contained in the insulation resin material.

### <2.2. On the Formation of Vias>

There is no particular limitation to the method of forming vias in an interconnect substrate containing the above mentioned substrate resin. Viz., any known methods, such as laser working or drilling, may be used. Specifically, for the laser working, the methods known per se, such as conformal mask method or direct laser method, may be used. Also, any of lasers used in general for boring miniscule holes may be used. For example, the CO₂ laser, YAG laser or the excimer laser may be used. Moreover, an argon laser or a helium-neon laser, as gas laser, a sapphire laser, as solid laser, a dye laser, a semiconductor laser or a free electron laser may be used.

There is also no limitation to the sorts of the vias formed. Viz., in forming trenches, the method for surface processing according to the present embodiment may be applied in the same way as in forming known types of vias, such as blind vias or through-holes.

There is also no limitation to the size ranges of the vias, such as the ranges of their aspect ratios, diameters or depths. Viz., the method for surface processing according the present embodiment may be applied to a variety of via sizes.

In the method for surface processing according the present embodiment, smears left over at the bottom of the vias, bored by say working with a laser, may efficiently be removed without using strong oxidants used in the related art techniques, such as permanganates. By embedding plating metal in the vias in the course of the subsequent plating processing, a metalized inner layer circuit may be electrically connected to the surface of the interconnect substrate, at the same time as an interconnect pattern is formed.

### <2-3. On the First Processing Step>

In the method for surface processing according the present embodiment, the substrate, in which a via or the like has been formed as described above, is immersed in a first processing solution by way of performing a first processing. The first processing solution and the first processing are sometimes referred to below as a conditioning processing solution and a conditioning processing, respectively. The first processing solution is weakly acidic to weakly alkaline and contains at least hydrogen peroxide.

### <2-3-1. First Processing Solution>

Initially, the first processing solution (conditioning processing solution) used in the first processing step will be explained. As noted above, the first processing solution contains hydrogen peroxide and is of a pH ranging from weakly acidic to weakly alkaline.

Although there is no particular limitation to the concentration of hydrogen peroxide in the first processing solution, it is preferably 1 to 200 g/lit. If the concentration of hydrogen peroxide is lower than 1 g/lit, the speed of the catalytic cracking reaction of hydrogen peroxide on the surface of the inner metalized layer, such as inner copper layer, becomes lower. It is thus not possible to generate a sufficient quantity of an oxygen gas to remove the smear. On the other hand, if the concentration of hydrogen peroxide is greater than 200 g/lit, self-cracking of hydrogen peroxide may become extremely vigorous such as to detract from economical advantages.

In case of processing an interconnect substrate including a copper interconnect (copper circuit), a chelating agent for copper may be contained in the first processing solution. In case the chelating agent for copper is contained in this manner in the first processing solution, it is possible to suppress self-cracking of hydrogen peroxide to remove the smear efficiently. It is also possible to prevent the processing solution from becoming turbid due to formation of copper hydroxide.

Although there is no particular limitation to the chelating agents, these may, for example, be amines, polyamines, alkanol amines, carboxylic acids, amino acids, amino polycarboxylic acids, phosphonic acids, sulfonic acids and salts thereof. Specifically, the amines may be enumerated by, for example, tri-n-butyl amine, 2-ethylhexyl amine and triisobutyl amine. The polyamines may be enumerated by, for example, ethylene diamine, triethylene tetramine, hexamethylene tetramine and pentaethylene hexamine. The alkanol amines may be enumerated by, for example, monoethanol amine, diethanol amine, triethanol amine, 1-amino-2-propanol, 2-(2-aminoethoxy)ethanol and triisopropanolamine. The carboxylic acids may be enumerated by, for example, formic acid, acetic acid, propionic acid, butyric acid, oxalic acid, malonic acid, succinic acid, benzoic acid, phthalic acid, salicylic acid, tartaric acid, citric acid, gluconic acid, glyoxylic acid and malic acid. The amino acids may be enumerated by glycine, glutamic acid and aspartic acid. The amino polycarboxylic acids may be enumerated by, for example, ethylene diamine tetraacetic acid, nitrilotriacetic acid, diethylene triamine pentaacetatic acid, trisodium hydroxyethyl ethylene diamine triacetate, 2-diaminopropane-N,N,N′, N′ tetraacetic acid, trans-1,2-cyclohexanediamine tetraacetic acid, and glycoletherdiamine tetraacetic acid. The phosphonic acids may be enumerated by, for example, 1-hydroxyethane-1,1-diphosphonic acid, aminophosphonic acid, aminotrimethylene phosphonic acid, N,N,N′,N′-ethylene diamine tetrakis (methylenephosphonic acid), diethylene triamine pentamethylene phosphonic acid, and polyoxypropylene diamine tetramethylene phosphonic acid. The sulfonic acids may be enumerated by, for example, sulfamic acid (aminosulfonic acid) and 2-aminoethane sulfonic acid.

Although there is no particular limitation to the concentration of the chelating agent for copper, it is preferably 0.01 to 50 g/lit. If the concentration of the chelating agent is less than 0.01 g/lit, self-cracking of hydrogen peroxide may not be effectively suppressed, while the desirable effect of suppressing copper hydroxide from being generated may not be demonstrated. If, on the other hand, the concentration of the chelating agent is greater than 50 g/lit, there may not be obtained a desirable effect accompanying the increase in the concentration, thus bringing about economical disadvantages. In addition, the inner metalized layer tends to be etched excessively.

In the first processing solution, there may be contained a stabilizer for hydrogen peroxide. In case the stabilizer for hydrogen peroxide is contained in the first processing solution, self-cracking of hydrogen peroxide may be suppressed even if the processing solution is used for prolonged time, thus assuring efficient de-smearing processing.

Although there is no limitation to the stabilizers, these may be amines, glycols and glycol ethers, for example. Specifically, the glycols may be enumerated by, for example, ethylene glycol, diethylene glycol, triethylene glycol, dipropylene glycol, polyethylene glycol, 1,2-propanediol, 1,3-propanediol, 1,2-butanediol, 1,3-butanediol, 1,4-butanediol, 2,3-butanediol, 1,5-pentanediol and glycerin. The glycol ethers may be enumerated by, for example, ethylene glycol monoalkylether, ethylene glycol dialkylether, diethylene glycol monoalkylether, diethylene glycol dialkylether, triethylene glycol monoalkylether, triethylene glycol dialkylether, propylene glycol monoalkylether, propylene glycol dialkylether, dipropylene glycol monoalkylether, dipropylene glycol dialkylether, glycol monoalkylether, polyethylene glycol, polyethylene glycol monoether, polyethylene glycol dialkylether, ethylene glycol monophenylether, diethylene glycol monophenylether, and triethylene glycol monophenylether. It is observed that the amines may be the same as the compounds listed above as the chelating agents for copper.

Although there is no limitation to the concentration of the stabilizer, it is preferably 0.01 to 50 g/lit. If the stabilizer concentration is less than 0.01 g/lit, self-cracking of hydrogen peroxide may not be suppressed effectively. On the other hand, if the stabilizer concentration is higher than 50 g/lit, there may not be obtained desirable effects accompanying the increase in the concentration, thus bringing about economical disadvantages. In addition, there is a possibility that the stabilizer becomes affixed to and left over on the substrate surface.

The first processing solution has a pH that ranges from weakly acidic to weakly alkaline, as set out above. With the pH of the first processing solution thus ranging from weakly acidic to weakly alkaline, it is possible to suppress that the inner metalized layer is excessively etched to render it possible to remove the smear efficiently. In more concrete terms, the pH is preferably not less than 4 and not more than 8. In case the pH is less than 4, an oxide film, formed by the oxidizing action of hydrogen peroxide on the inner metalized layer and which is to operate as a protective film, tends to be dissolved by an acid, with the possibility that the inner metalized layer is dissolved. If, on the other hand, the pH is higher than 8, hydrogen peroxide undergoes self-cracking by an alkali such that a proper hydrogen peroxide concentration may not be maintained.

To maintain the pH of the first processing solution in the range from weakly acidic to weakly alkaline, a pH adjustment or buffering agent may be contained in the first processing solution. By having the pH adjustment or buffering agent contained in the first processing solution, the first processing solution may reliably be maintained in the range from weakly acidic to weakly alkaline. Hence, it becomes possible to suppress that the smear removing performance by the catalytic cracking reaction of hydrogen peroxide on the metal surface is lowered, thus achieving an efficient smear removing processing.

There is no particular limitation to the pH adjustment or buffering agent. Specifically, as the pH adjustment or buffering agent, ammonia, amines, polyamines, polyalkanol amines or salts thereof; carboxylic acids, amino acids, amino polycarboxylic acids, sulfonic acids, phosphonic acids, phosphoric acids, sulfuric acid, hydrochloric acid or salts thereof, may be used. In more concrete terms, the phosphoric acids may be enumerated by phosphoric acid, pyrophosphoric acid, metaphosphoric acid, polyphosphoric acid, hypophosphorous acid and phosphorous acid. As for the other compounds, the compounds, listed above, may be used.

Although there is no limitation to the concentration of the pH adjustment or buffering agent, it is preferably in a range from 0.001 to 5 mol/lit. If the concentration is less than 0.001 mol/lit, the pH of the processing solution may not be satisfactorily maintained in a preset range. If, on the other hand, the concentration of the pH adjustment or buffering agent is greater than 5 mol/lit, the concentration is lowered appreciably by drag out, thus bringing about economical disadvantages.

It is also possible that a surfactant is contained in the first processing solution. If the surfactant is contained in this manner in the first processing solution, it is possible to improve the permeation performance of the first processing solution into the bulk of the substrate as well as to improve the performance of anti-foaming and mist suppression.

Specifically, as the surfactant, any of the nonionic, anionic, cationic or amphoteric surfactants may be used. One or more of these surfactants may be used either alone or in combination. The nonionic surfactants may be enumerated by etheric surfactants, ether/ester surfactants, ester surfactants and nitrogen-containing surfactants. Examples of the etheric surfactants may include polyoxyethylene alkyl ethers, polyoxyethylene alkyl phenyl ethers, alkylallyl formaldehyde condensed polyoxyethylene ethers, polyoxyethylene propylene block copolymers and polyoxyethylene polyoxypropylene alkyl ethers. Examples of the ether/ester surfactants may include polyoxyethylene glycerin fatty acid esters, polyoxyethylene sorbitan fatty acid esters, polyoxyethylene sorbitol fatty acid esters and polyoxyethylene fatty acid alkanolamide sulfates. Examples of the ester surfactants may include polyethylene glycol fatty acid esters, ethylene glycol fatty acid esters, glycerin fatty acid esters, polyglycerin fatty acid esters, sorbitan fatty acid esters, propylene glycol fatty acid esters and cane sugar fatty acid esters. Examples of the nitrogen-containing surfactants may include fatty acid alkanol amides, polyoxyethylene fatty acid amides and polyoxyethylene alkylamines. Turning to the anionic surfactants, examples of these may include salts (sodium or potassium salts) of carboxylic acids with 12 to 18 carbon atoms, such as lauric acid, myristic acid, palmitic acid, stearic acid or oleic acid. Other examples may include N— acylamino acids with 12 to 18 carbon atoms, N-acylamino acid salts, polyoxyethylene alkylether carboxylates, carboxylates with 12 to 18 carbon atoms, such as acylated peptides, alkyl sulfonates, alkylbenene sulfonates, alkylnaphthalene sulfonates and naphthalene sulfonate formalin polycondensates. Other examples may include sulfosuccinates, sulfonates, such as α-olefin sulfonates or N-acylsulfonates, sulfated oil, alkyl sulfates, alkyl ether sulfates, polyoxyethylene sulfates, polyoxyethylene alkylallylether sulfates, alkylamide sulfates or the like sulfates. Still further examples may include polyoxyethylene alkyl ether phosphates, polyoxyethylene alkyl phenylether sulfates, alkyl phosphates or the like phosphates. The amphoteric surfactants may be enumerated by imidazolium betaine and lecithin, in addition to carboxy betaine surfactants and aminocarboxylates.

Although there is no limitation to the concentration of the surfactant, it is preferably in a range from 0.1 to 20000 mg/lit. If the surfactant concentration is less than 0.1 mg/lit, it is not possible for the surfactant to demonstrate sufficient desirable effects in improving the permeation performance of the first processing solution into the bulk of the substrate, improving the anti-foaming performance or in improving the mist suppressing performance. On the other hand, if the surfactant concentration is greater than 20000 mg/lit, there may be obtained no desirable effect accompanying the increase in the concentration, thus bringing about economical disadvantages. In addition, there is a possibility that excessively vigorous foaming occurs on the surface of the inner metalized layer due to hydrogen peroxide at the time of oxygen gas generation.

### <2-3-2. First Processing Step>

In the method for surface processing according to the present embodiment, the substrate is immersed in the above mentioned first processing solution (conditioning processing solution). By immersing the substrate in the first processing solution, which is maintained in a range from weakly acidic to weakly alkaline, hydrogen peroxide may be brought into contact with the surface of a copper oxide film which is the inner metalized layer exposed to the bottom of say a via formed in the substrate. This causes a cracking reaction of hydrogen peroxide (catalytic cracking reaction). By such catalytic cracking reaction, the oxygen gas may be generated. Due to the foam of the so generated oxygen gas, the smear left on the surface of the via bottom may be floated away from the inner metalized layer, such as inner copper layer, thereby effectively achieving smear removal.

Moreover, since the oxygen gas is generated by the catalytic cracking reaction of hydrogen peroxide as a result of the processing of the substrate with the first processing solution, an oxide film may be formed on the surface of the inner metalized layer, such as inner copper layer. The oxide film, thus formed on the surface of the inner metalized layer by the catalytic cracking reaction of hydrogen peroxide, may be used as a protective film for protecting the inner metalized layer such as to suppress excess etching of the inner metalized layer.

In the related art of the processing for smear removal, potent oxidants, exemplified by permanganates or chromates, were used. The use of such potent oxidants may lead to destruction of those substrate sites where the smear removal processing is unneeded, while leading to excessive etching of the substrate, thus deteriorating the interconnect reliability. It is therefore necessary in the related art of processing to strictly manage e.g., the processing time. In addition, the potent oxidants may lead to problems concerned with management against environmental pollution, disposal of wastage or preservation.

In the method for surface processing by the above mentioned embodiment of the present invention, the surface of the printed circuit board is processed with the weakly acidic to weakly alkaline first processing solution at least containing hydrogen peroxide. The smear on the surface of the printed circuit board may be floated by oxygen generated by the catalytic cracking reaction of hydrogen peroxide. The smear may thus be effectively removed as excessive etching of the inner metalized layer is suppressed.

In this manner, the smear may be removed, while the oxide film may be formed on the surface of the inner metalized circuit based on oxidation by the catalytic cracking reaction of hydrogen peroxide. It is thus possible to prevent excess etching and consequent scraping off of the inner metalized circuit. In addition, it is possible to suppress damages otherwise inflicted on those sites of the substrate where it is unnecessary to perform the processing of smear removal.

In addition, in comparison with the case of using potent oxidants, such as permanganates or chromates, as in the related art techniques, the processing for smear removal may be improved in safety, while the load on the environment may be decreased appreciably.

Although there is no particular limitation to the processing temperature used for the first processing step, it is preferably set to 10 to 60° C. Although there is again no particular limitation to the processing time duration, it is preferably set to 1 to 30 minutes and more preferably set to 5 to 15 minutes. In case the processing time duration is less than 1 minute, no sufficient smear removing effect may be derived, whereas, if the processing time duration is longer than 30 minutes, the processing throughput is lowered, thus bringing about economical disadvantages.

In the first processing step, the substrate is immersed in the first processing solution for processing, as set out above. Although the processing by immersion is desirable in that the substrate may be brought into sufficient contact with the first processing solution to allow efficient smear removal, the present invention is not limited to this processing. For example, the first processing solution may be ejected by a sprayer onto the substrate, provided the sufficient smear removing effect may thereby be achieved.

During this first processing step, it is desirable to use ultrasonic processing in combination. By using the ultrasonic processing simultaneously, it is possible to further improve the smear removal efficiency. As the condition for ultrasonic processing, the frequency of the ultrasonic wave is preferably set to 20 to 200 kHz. If the frequency of the ultrasonic wave is higher than 200 kHz, the smear removing effect may not be demonstrated sufficiently. If the frequency of the ultrasonic wave is less than 20 kHz, the smear removing effect may not be sufficient, while the damage to the substrate is increased. On the other hand, the time duration of ultrasonic processing is preferably 1 to 30 minutes and more preferably 5 to 15 minutes. If the time duration of ultrasonic processing is less than 1 minute, the smear removal effect may be insufficient. If the time duration of ultrasonic processing is longer than 30 minutes, the processing throughput is lowered to bring about economic disadvantages. In addition, the inner metalized layer may be etched excessively.

### <2-4. On the Second Processing Step>

In the method for surface processing of the present embodiment, a second processing is effected after the above mentioned first processing step. This second processing, sometimes referred to below as the ‘alkali cleaning processing’, immerses the interconnect substrate, processed by the first processing step, in a second processing solution at least containing an alkali compound and an organic solvent. The second processing solution is sometimes referred to below as the ‘alkali cleaning processing solution’.

### <2-4-1. Second Processing Solution>

Initially, the second processing solution (alkali cleaning processing solution) used in this second processing step will be explained. The second processing solution contains at least the alkali compound and the organic solvent, as mentioned previously.

The alkali compound used may be an inorganic alkali compound or an organic alkali compound. Or, the alkali compound used may contain both the inorganic alkali compound and the organic alkali compound. Specifically, the inorganic alkali compound may be enumerated by a water-soluble metal oxide, such as, for example, sodium hydroxide, potassium hydroxide, lithium hydroxide and calcium hydroxide. These may be used either singly or in combination. The organic alkali compound may be enumerated by, for example, ammonia, tetraalkyl ammonium hydroxides, amines, polyamines and polyalkanol amines, which may be used either singly or in combination.

Although there is no particular limitation to the concentration of the alkali compounds in the second processing solution, it is preferably set to 0.1 to 200 g/lit. If the concentration of the alkali compounds is set to less than 0.1 g/lit, the smear removing effect may not be demonstrated sufficiently. If it is set to greater than 200 g/lit, and the organic alkali compound is used, the inner metalized layer, e.g., the inner copper layer, may be etched excessively. On the other hand, the concentration is lowered appreciably by drag out, thus bringing about economical disadvantages.

The second processing solution also contains the organic solvent. In more concrete terms, the second processing solution contains at least one organic solvent selected from the group consisting of glycols, glycol ethers, alcohols, cyclic ethers, cyclic ketones, lactams and amides.

Specifically, the glycols and glycol ethers may be the same as those mentioned above. The alcohols may be enumerated by, for example, methanol, ethanol, 1-propanol, 1-butanol, 2-butanol, iso-butanol, tert-butanol, 1-pentanol, 2-pentanol, 3-pentanol, 2-methyl-1-butanol, iso-pentyl alcohol, tert-pentyl alcohol, 3-methyl-2-butanol, neopentyl alcohol, 1-hexanol, 2-methyl-1-pentanol, 4-methyl-2-pentanol, 2-ethyl-1-butanol, 1-heptanol, 2-heptanol, 3-heptanol, cyclohexanol, 1-methylcyclohexanol, 2-methylcyclohexanol, 3-methylcyclohexanol and 4-methylcyclohexanol. The cyclic ethers may be enumerated by, for example, tetrahydrofuran, 2-methyl tetrahydrofuran, tetrahydropyran, 1,3-dioxolan, 4-methyl-1,3-dioxolan, 1,3-dioxane, 4-methyl-1,3-dioxane and 1,3-benzodioxol. The cyclic ketones may be exemplified by, for example, cyclohexanone, cyclopentanone and cycloheptanone. The lactams may be exemplified by, for example, 2-pyrrolidone and N-methyl-2-pyrrolidone. The amides may be exemplified by, for example, formamide, N-methyl formamide, N,N-dimethyl formamide, acetoamide, N-methyl acetoamide, N,N-dimethyl acetoamide and N,N,N′,N′-tetramethylurea.

Although there is no particular limitation to the concentration of the organic solvent in the second processing solution, it is preferably 1 to 700 g/lit. If the concentration of the organic solvent is less than 1 g/lit, no sufficient smear removing effect may be demonstrated. If the concentration of the organic solvent is greater than 700 g/lit, the concentration is lowered excessively due to drag out, thus bringing about economic disadvantages. Since anti-explosion means have to be used in handling the solvents, depending on the species of the solvents used, equipment and running costs may be increased, thus bringing about economic disadvantages.

In processing an interconnect substrate having copper interconnects, the second processing solution may contain a chelating agent for copper. By having the chelating agent for copper contained in the second processing solution, smear removal may effectively be effected by the above mentioned alkaline compound and the organic solvent. It is also possible to prevent the processing solution from becoming turbid due to generation of copper hydroxide.

Specifically, the chelating agents for copper may be the same as those contained in the first processing solution.

Although there is no limitation to the concentration of the chelating agent for copper, it is preferably in a range from 0.1 to 50 g/lit. If the concentration of the chelating agent is less than 0.1 g/lit, no sufficient effect may be obtained in suppressing the generation of copper hydroxide. If the concentration of the chelating agent is higher than 50 g/lit, there may be obtained no desirable effect accompanying the increase in the concentration, thus bringing about economical disadvantages. In addition, the inner metalized layer tends to be etched excessively.

The second processing solution may also contain a surfactant. By having the surfactant thus contained in the second processing solution, it is possible to improve the permeation performance of the second processing solution to the substrate and the anti-foaming performance as well as to display mist suppressing effects.

Specifically, as the surfactant, any of the nonionic, anionic, cationic and amphoteric surfactants, listed above in connection with the first processing solution, may be used. These surfactants may be used either singly or in combination.

Although there is no particular limitation to the concentration of the surfactant, it is preferably in a range from 0.1 to 20000 mg/lit. If the surfactant concentration is less than 0.1 mg/lit, the effect of improving the permeation performance of the second processing solution into the substrate and the anti-foaming performance as well as the mist suppressing effect may not be demonstrated satisfactorily. On the other hand, if the surfactant concentration is greater than 20000 mg/lit, there may be obtained no desirable effect accompanying the increase in the concentration, thus bringing about economical disadvantages.

### <2-4-2. Second Processing Step>

In the method for surface processing according to the present embodiment, the substrate processed by the first processing step is immersed in the above mentioned second processing solution (alkaline cleaning processing solution). By having the substrate immersed in the second processing solution after the first processing step, the smear as well as the resin transmuted by heat of laser working and thus deteriorated in mechanical strength or in resistance against chemicals may be attacked and removed by the alkaline compound and the organic solvent contained in the second processing solution. It is observed that the smear to be attacked and removed is that left over say on the via bottom throughout the first step.

Moreover, in the second processing step, the adhesion between the substrate resin and the inner copper layer circuit (copper interconnect) may be improved in tightness by say roughening processing by the second processing solution containing the alkaline compound and the organic solvent. In addition, in the second processing step, the oxide film, generated on the surface of the metalized circuit by the catalytic cracking reaction of hydrogen peroxide during the first processing step, may be dissolved and removed. By dissolving and removing the oxide film, deposited on the surface of the inner metalized layer circuit, it is possible to form a gap between the inner metalized layer circuit and the smear to further lower the tightness of contact between the inner metalized layer and the smear to further promote the smear removal. Also, by dissolving and removing the oxide film, it is possible to raise the tightness of adhesion between the inner metalized layer circuit and the plating metal film to be formed in the subsequent step to improve the interconnection reliability of the interconnect substrate.

Although there is no limitation to the processing temperature in the second processing step, it is preferably 10 to 90° C. and more preferably to 40 to 80° C. Although there is again no limitation to the processing time duration, it is preferably 1 to 30 minutes and more preferably to 5 to 15 minutes. If the processing time duration is less than one minute, no sufficient smear removing effect may be displayed, whereas, if the processing time duration is longer than 30 minutes, the processing throughput is lowered, thus bringing about economical disadvantages.

In the second processing step, the substrate from the first processing step is immersed in the second processing solution for processing. The processing by immersion is desirable from the perspective that the second processing solution may be sufficiently contacted with the substrate to permit efficient smear removal. However, the present invention is not limited to this processing. For example, the first processing solution may be ejected by a sprayer onto the substrate, provided the sufficient smear removing effect may thereby be achieved.

During this second processing step, it is desirable to use ultrasonic processing in combination. By using the ultrasonic processing simultaneously, it is possible to further improve the smear removal efficiency. As the condition for ultrasonic processing, the same condition as that used in the first processing step may be used.

### 3. Plating Processing

In the method for surface processing according to the present embodiment, the interconnect substrate is processed by the first processing solution and by the second processing solution, in this order, as set out above. The first processing solution at least contains hydrogen peroxide and has a pH ranging from not less than 4 to not more than 8, that is, from weakly acidic to weakly alkaline. The second processing solution contains at least an alkaline compound and an organic solvent. The smear generated as a result of forming the vias or the like in the substrate resin material may thus be efficiently removed. The plating processing is then effected on the so processed interconnect substrate to form a plating film on the resin substrate.

In the following, the processing of forming a copper plating film by the full additive method will specifically be explained. It is observed that the metal plating film is not limited to the copper plating film and may be a plating film of nickel or other metals. On the other hand, the method of plating processing is not limited to the full additive method and may also be a semi-additive method to form a plating film by electroplating.

Initially, the resin substrate is cleaned by cleaning processing by any related art of cleaning method. For the cleaning processing, a resin substrate, surface-processed as described above, is immersed say for five minutes at 65° C. in a cleaning solution to free the substrate surface of dust and dirt as well as to impart water-wettability to the resin substrate. The cleaning processing may be made using an acidic solution or an alkaline solution. This cleaning processing may clean the surface of the resin substrate to further improve tightness in adhesion to the substrate of the plating film to be formed in a subsequent step.

After cleaning the resin substrate, a catalyst is afforded to the surface of the resin substrate on which a circuit pattern is to be formed. The catalyst afforded may, for example, be a catalyst solution containing bivalent palladium ions (Pd²⁺), such as a mixed solution of palladium chloride (PdCl₂.2H₂O), stannous chloride (SnCl₂.2H₂O) and hydrochloric acid (HCl). Turning to the concentration of the mixed solution, the concentration of Pd may be 100 to 300 mg/lit, that of Sn may be 10 to 20 g/lit and that of HCl may be 150 to 250 mlit/lit. The resin substrate is immersed in the catalyst solution for 1 to 3 minutes at a temperature of 30 to 40° C. to allow a Pd—Sn colloid to be adsorbed onto the resin substrate surface. The resin substrate was then immersed in an accelerator (promotor) composed of 50 to 100 mlit/lit of sulfuric acid or hydrochloric acid to activate the catalyst. This processing of activation removes tin of the complex compound to yield a particle having palladium adsorbed thereon. The palladium-adsorbed particle is ultimately used as a palladium catalyst to promote copper precipitation in subsequent electroless copper plating.

Meanwhile, sodium hydroxide or an ammonia solution may be used as an accelerator. In affording the catalyst to the resin substrate, pre-processing may be effected, using a conditioning solution or a pre-dip solution, in order to further improve the tightness of adhesion between the resin substrate and the copper plating film. Pre-processing may also be performed in order to improve the tightness of contact of the catalyst with respect to the resin substrate. The catalyst solution may, of course, be selected arbitrarily without being limited to those set out above.

After affording the catalyst to the resin substrate, as described above, a plating resist is formed in order to form a desired circuit pattern. Viz., such a resist pattern is formed which will mask the portions of the resin substrate on which a copper plating film is to be deposited to form the circuit pattern in the next step. Although the resist pattern may be detached and removed by say etching after the end of the plating, it may also be left, without being detached and removed, for use subsequently as a soldering resist. The plating resist may be formed using any known methods.

When the plating resist has been formed on the insulation substrate, there has been formed a fine texture on the substrate. A copper plating film, which is to become the circuit pattern, is formed on this insulating substrate by plating processing such as electroless plating.

For the plating processing, a plating solution containing EDTA as a chelating agent may, for example, be used as an electroless plating solution. As an example composition of the electroless copper plating bath, such a plating bath containing copper sulfate (10 g/lit) and EDTA (30 g/lit) and which is adjusted to a pH of 12.5 by sodium hydroxide may be used. It is also possible to use an electroless copper plating solution containing a Rochelle salt as a chelating agent. The insulation resin substrate is immersed for 30 to 600 minutes under a temperature condition of say 60 to 80° C. in the electroless copper plating solution to form a copper plating film. If the via or the like has been formed for providing electrical conduction to the lower layer in the multi-layered interconnect substrate, it is preferred to stir the solution sufficiently to supply a sufficient quantity of ions to the via. For stirring, pneumatic agitation or circulation by a pump may be used.

In precipitating a copper plating film by an electroless plating method, palladium adsorbed particles, as catalyst, affixed to the resin substrate surface, may be reduced, after forming the plating resist, by say a 10%-sulfuric acid and a reducer. By so doing, the catalyst is activated to promote deposition of a copper plating film on the resin substrate.

To further improve the tightness of adhesion of the plating film to the resin substrate material, the plating processing may be effected in two stages. Viz., an underlying plating film is formed on the resin substrate, by way of the initial plating processing, after which a secondary plating processing is effected. In this secondary plating processing, a thicker plating film of a film thickness greater than the underlying plating film already formed is formed by electroplating on the underlying plating film to form a circuit pattern. It is observed that the initial plating processing is to be effected using an electroplating bath which is selected as follows. Viz., the electroplating bath used in the initial plating processing is such a one that will form the underlying plating film exhibiting an inner stress, in general a tensile inner stress, that is opposite in direction to the inner stress of the plating film of greater film thickness to be formed in the secondary plating processing.

As noted above, the smear left on the bottom of the via or the like is efficiently removed by the surface processing method of the present embodiment, and a circuit may then be formed on the interconnect substrate by plating processing. It is possible in this manner to form an interconnect substrate freed of disconnections or failure in electrical conduction and which is thus improved in interconnect reliability.

Of course, the plating bath used in the above mentioned plating processing, its composition or the processing conditions of the plating processing is merely given by way of example and is not intended to limit the present invention.

The above is a specified example of plating processing employing an electroless copper plating solution. It is observed that the plating metal is not limited to copper, and an electroless nickel plating bath, for example, may also be applied satisfactorily. An example composition of a nickel plating bath is a plating bath containing nickel sulfate (20 g/lit), sodium hypophosphite (15 g/lit) and a citrate (30 g/lit) and adjusted to a pH of 8 to 9.

As the method for plating processing, not only the plating processing by the full-additive method but also that by a semi-additive method may be used to form a plating film by electroplating.

### 4. Summary

As described above, the method for surface processing according to the present embodiment is a surface processing method for removing the smear left on the bottom of a via or the like formed in the substrate of the printed circuit board. The method for surface processing comprises a first processing step of immersing the substrate of the printed circuit board in a weakly acidic to weakly alkaline first processing solution of a pH not less than 4 and not greater than 8 at least containing hydrogen peroxide, and a second processing step of immersing the substrate of the printed circuit board, processed by the first processing step, in a second processing solution at least containing an alkaline compound and an organic solvent.

By processing the interconnect substrate by the first and second processing solutions, in this manner, the smear formed in the via or the like may be removed effectively. It is unnecessary to carry out the de-smearing processing in the related art which uses potent oxidants, such as permanganates or chromates, which are expensive and impose significant loads on the environment or on operators. By using the present processing, such an interconnect substrate may be obtained which exhibits improved tightness in adhesion between the inner metalized layer and plating metal as well as high interconnect reliability.

The present invention is not limited to the particular embodiment disclosed and may comprise variations which do not depart from the purport of the invention.

The present invention is not limited to a method for producing an interconnect substrate described in connection with the above embodiment or to the manufacture of a high density multi-layer interconnect substrate by a buildup technique. For example, the present invention may also be applied to the process for producing a multi-layer interconnect in CSP (Chip Size Epoxy Package or Chip Scale Epoxy Package) or TCP (Tape Carrier package) of the wafer level.

### 5. Examples

Several concrete Examples of the present invention will now be explained. It is observed that the present invention is not to be restricted to any of the following Examples.

### EXAMPLES

### Example 1

Initially, using a laser working device, manufactured by Hitachi Via Mechanics, Ltd., a blind via was formed in a substrate formed by a plurality of layers of a commonplace insulation resin material manufactured by Ajinomoto Fine-Techno Co., Inc., under a trade name of ABF-GX13. The blind via was formed so that it will get to a lower copper foil layer of the insulation resin layers.

The substrate then was immersed at 40° C. for ten minutes in the first processing solution (conditioning processing solution), shown below, as the ultrasonic wave was continuously applied by an ultrasonic rinsing device manufactured by Chiyoda Co., Ltd.

### <Conditioning Processing Solution (First Processing Solution)>

hydrogen peroxide: 30 g/lit
polyethylene glycol: 0.5 g/lit
ethylene glycol monophenylether: 0.5 g/lit
disodium ethylenediamine tetraacetate: 0.5 g/lit
ammonium sulfate: 15 g/lit

The first processing solution was adjusted to a pH of 6 using sulfuric acid and sodium hydroxide.

The substrate processed was then immersed at 60° C. for ten minutes in the following second processing solution (alkaline cleaning processing solution), under continuous irradiation of ultrasonic wave by an ultrasonic rinsing device manufactured by Chiyoda Co., Ltd.

### <Alkaline Cleaning Processing Solution (Second Processing Solution)>

sodium hydroxide: 40 g/lit
monoethanolamine: 75 g/lit
n-methyl-2-pyrrolidone: 300 g/lit

The smear at the blind via bottom was then observed.

A catalyst was then afforded to the substrate by a catalyst affording process (Thru-Cup process by a cleaner conditioner ACL-009, pre-dip PED-104, a catalyst AT-105 and an accelerator AL-106, all manufactured by C. Uyemura & Co., Ltd. the present Assignee. An electroless copper plating processing was then effected using an electroless copper plating solution, manufactured by C. Uyemura & Co., Ltd. under a trade name of PEA, in order to form a plating film 0.5 μm in thickness.

Using a copper electroplating solution, manufactured by C. Uyemura & Co., Ltd. under a trade name of ETN, copper electroplating was effected in order to deposit a copper plating film to a thickness of 30 μm. It is noted that washing with lukewarm water, washing with water and drying were effected from time to time during the processing of conditioning, alkaline cleaning, electroless plating and electroplating.

The interconnect substrate, manufactured as described above, was placed under a load by a cold/hot heat impact device, and subsequently put to a conduction test to check for tightness in adhesion and for the connectivity performance of the copper plating film and the inner layer copper foil.

### Example 2

The processing was carried out in the same way as in Example 1 except using the first processing solution (conditioning processing solution) and the second processing solution (alkaline cleaning processing solution) shown below:

### <Conditioning Processing Solution (First Processing Solution)>

hydrogen peroxide: 30 g/lit
polyethylene glycol: 1 g/lit
1,2-diaminopropane-N,N,N′,N′-tetraacetic acid: 1 g/lit
N,N,N′,N′-ethylenediaminetetrakis(methylene phosphonic acid) hydrate: 0.5 g/lit

The first processing solution was adjusted to pH 6 with sodium hydroxide.

### <Alkaline Cleaning Processing Solution (Second Processing Solution)>

sodium hydroxide: 40 g/lit
2-(2-aminoethoxy)ethanol: 75 g/lit
diethylene glycol dibutylether: 300 g/lit

### Comparative Example 1

The processing was carried out in the same way as in Example 1 except that the first processing solution was adjusted to a pH of not higher than 2 with sulfuric acid and sodium hydroxide.

### Comparative Example 2

The processing was carried out in the same way as in Example 1 except not carrying out the processing of conditioning on the substrate in which the blind via has been formed.

Viz., the substrate, in which the blind hole was formed beforehand, was immersed at 60° C. for ten minutes in the alkaline processing solution used in Example 1, at the same time as the substrate was irradiated with an ultrasonic wave using an ultrasonic rinsing device manufactured by Chiyoda Co., Ltd. The smear at the blind via bottom was then observed. Then, pre-processing, electroless copper plating and copper electroplating were carried out, and inspection was made of the connection performance between the copper plating film and the inner layer copper foil using a cold/hot heat impact device.

### Comparative Example 3

Alkaline cleaning was not carried out after the processing of conditioning for a substrate in which a blind via was formed beforehand. Otherwise, processing was carried out in the same way as in Example 1.

Viz., the substrate, in which a blind via was formed beforehand, was immersed at 40° C. for ten minutes in the conditioning solution used in Example 1, at the same time as the substrate was irradiated with an ultrasonic wave from an ultrasonic rinsing device manufactured by Chiyoda Co., Ltd. Without doing alkaline cleaning processing, the smear on the blind via bottom was observed. Then, pre-processing, electroless copper plating and copper electroplating were carried out and inspection was made of the connection performance between the copper plating film and inner layer copper foil using a cold/hot heat impact device.

### Reference Example 1

The substrate, in which a blind via was formed beforehand, was put to processing with swelling, using a swelling agent manufactured by C. Uyemura Co., Ltd. under a trade name of DEC-501. The resultant product was roughed at 80° C. for 15 minutes, using a resin etching solution composed of 55 g/lit of sodium permanganate and 40 g/lit of sodium hydroxide. The resulting product was reduced, using a reducing solution, manufactured by C. Uyemura Co., Ltd. under a trade name of DEN-503H.

The smear on the blind via bottom was then observed.

Then, pre-processing, electroless copper plating and copper electroplating were carried out in the same way as in Example 1, and inspection was then made of the connection performance between the copper plating film and the inner layer copper foil.

In the above Examples, Comparative Examples and the Reference Example, the smear on the blind via bottom was observed using an optical microscope. By way of inspection of the connection performance of the interconnect substrate, cyclic processing of −65° C.×15 minutes and processing of +150° C.×15 minutes were repeatedly carried out using a cold/hot heat impact device manufactured by ESPEC Corp. under a trade name of TSE-11. After load application of 1,000 cycles in this manner, a test on electrical conduction was carried out to make a decision. The respective results are shown in the following Table 1.

TABLE 1

| | Smear at the blind via bottom | Connection performance |
|---|---|---|
| Ex. 1 | no smear | good |
| Ex. 2 | no smear | good |
| Comp. Ex. 1 | no smear | not good |
| Comp. Ex. 2 | there is smear | not good |
| Comp. Ex. 3 | there is smear | not good |
| Ref. Ex. 1 | no smear | good |

From the results shown in Table 1, it may clearly be seen that, with the Examples 1 and 2, no smear was observed at the blind via bottom, indicating that the smear had been removed effectively. In the Examples 1 and 2, a substrate was immersed in the first processing solution that contained at least hydrogen peroxide and that was maintained in a weakly acidic to weakly alkaline state of a pH of not less than 4 and not more than 8, and the substrate was subsequently immersed in the second processing solution at least containing the alkaline compound and the organic compound, as previously mentioned. The interconnect substrate produced also showed good electrical conductivity. Moreover, the inner copper circuit layer was reliably affixed to the plating film, indicating that interconnect reliability of an interconnect substrate produced was high. It may thus be seen that the substrate of satisfactory performance may be obtained as in the case of the Reference Example 1 that uses permanganate in known manner for processing.

On the other hand, in Comparative Example 1, in which the first processing solution was of a pH of not greater than 2, no smear could be observed, thus indicating that the smear had effectively been removed. However, the copper of the inner layer was severely etched off. Moreover, the tightness in adhesion between the copper circuit and the plating film was insufficient, thus indicating that a substrate fabricated was not of a reliable connection performance.

In both the Comparative Examples 2 and 3, the smear was noticed at the blind via bottom, indicating that the smear could not be satisfactorily removed. It is observed that, in the Comparative Example 2, the first processing by hydrogen peroxide was not effected and only the second processing (alkaline processing) by the alkaline compound and the organic solvent was effected, whereas, in the Comparative Example 3, only the processing for conditioning by hydrogen peroxide was effected but alkaline cleaning was not effected. Moreover, in these Comparative Examples, the connection performance of the interconnect substrate was not good, and hence the adhesion of the copper circuit to the plating film was not sufficient in tightness, such that it was not possible to fabricate the substrate the substrate exhibiting the sufficient in interconnect reliability.

In the Reference Example 1, which used permanganate in known manner for processing, no smear was noticed on the blind via bottom, and the connection performance was good. However, if the handling or management of permanganates is taken into account, there is posed a problem in connection with the processing efficiency.

It is seen from the above result that, by carrying out the processing for conditioning followed by alkaline cleaning, it is possible to remove the smear without the necessity of using potent oxidants, such as permanganate. As set out above, the processing for conditioning is the processing of immersing the substrate in the first processing solution by way of conditioning processing and then in the second processing solution by way of alkaline cleaning. The first processing solution contains at least hydrogen peroxide and is maintained in a weakly acidic to weakly alkaline state of pH of not less than 4 and not more than 8, while the second processing solution at least contains the alkaline compound and the organic solvent. In this manner, an interconnect substrate may be obtained which is further improved in interconnect reliability.

What is claimed is:

1. A method for surface processing of a resin-containing interconnect substrate of a printed circuit board for removing smear left in an opening formed in the interconnect substrate, without etching an inner metal layer, the opening including a blind via, through-hole or a trench; the method comprising:
a first processing step of immersing the substrate of the printed circuit board in a weakly acidic to weakly alkaline first processing solution at least containing hydrogen peroxide; and
a second processing step of immersing the substrate of the printed circuit board, processed by the first processing step, in a second processing solution at least containing an alkaline compound and an organic solvent.

2. The method for surface processing according to claim 1, wherein
the first processing solution has a pH of not less than 4 and not more than 8.

3. The method for surface processing according to claim 1, wherein
the organic solvent is at least one selected from the group consisting of glycols, glycol ethers, alcohols, cyclic ethers, cyclic ketones, lactams and amides.

4. The method for surface processing according to claim 1, wherein
the first processing solution further contains a stabilizer for hydrogen peroxide.

5. The method for surface processing according to claim 4, wherein
the stabilizer for hydrogen peroxide is at least one selected from the group consisting of amines, glycols and glycol ethers.

6. The method for surface processing according to claim 1, wherein
ultrasonic processing is carried out in at least one of the first and second processing steps.

7. The method for surface processing according to claim 1, wherein
the printed circuit board includes a copper interconnect.

8. The method for surface processing according to claim 7, wherein
the first processing solution further contains a chelating agent for copper.

9. The method for surface processing according to claim 8, wherein
the chelating agent for copper contains at least one selected from the group consisting of amines, polyamines, alkanolamines, carboxylic acids, amino acids, amino polycarboxylic acids, phosphonic acids, sulfonic acids and salts thereof.

10. A surface processing agent for processing a resin-containing interconnect substrate of a printed circuit board for removing smear left over in an opening formed in the interconnect substrate, without etching an inner metal layer; the opening including a blind via, through-hole or a trench; the surface processing agent comprising:
a weakly acidic to weakly alkaline first processing solution at least containing hydrogen peroxide; and
a second processing solution at least containing an alkaline compound and an organic solvent;
the substrate of the printed circuit board being processed with the first processing solution, the substrate of the printed circuit board thus processed being processed with the second processing solution.
